(19) United States
(12) Patent Application Publication
(10) Pub. No.: US 2004/0049970 A1
(43) Pub. Date: Mar. 18, 2004

(54) Hydrodynamic effect surface lure

(76) Inventor: Stephen F. Brown, Danbury, WI (US)

Correspondence Address: FLEIT, KAIN, GIBBONS, GUTMAN, BONGINI, & BIANCO P.L., ONE BOCA COMMERCE CENTER, 551 NORTHWEST 77TH STREET, SUITE 111, BOCA RATON, FL, 33487, US

(21) Appl. No.: 10/652,108

(22) Filed: Aug. 29, 2003

Related U.S. Application Data
(60) Provisional application No. 60/407,510, filed on Aug. 29, 2002.

(51) Int. Cl. A01K 85/00

(52) U.S. Cl. 43/42

(57) ABSTRACT

A surface fishing lure includes a body, a hydrodynamic lip, a hook attachment, a line attachment, a counterweight, a propeller, and a propeller stabilizer. Advantageously, a surface fishing lure utilizing a preferred embodiment of the present invention is significantly more successful in attracting and catching large game fish, such as Muskie.

### CROSS-REFERENCE TO RELATED APPLICATION

This application is based upon and claims priority from prior U.S. Patent Application No. 60/407,510, filed Aug. 29, 2002, the entire disclosure of which is herein incorporated by reference.

### BACKGROUND OF THE INVENTION

1. Field of the Invention

The present invention generally relates to the field of fishing lures, and more particularly relates to surface lures that are used to attract and catch large game fish, such as Muskie.

2. Description of Related Art

Many surface lures have been designed to attract and catch game fish, most of which attempted to imitate prey fish floundering on the surface of the water. Some examples are: U.S. Pat. No. 4,827,660 issued to Dudeck which disclosed a surface lure with a hydrodynamic-effect body that oscillates; U.S. Pat. No. 4,435,914 issued to Norman which disclosed an elongated egg-shaped planer body with spinner journaled within a central upstanding opening; U.S. Pat. No. 4,510,710 issued to Hanna,et al., which disclosed a surface lure with a plurality of propellers and flotation devices; U.S. Pat. No. 2,653,408 issued to Bradley which disclosed a buoyant fishing lure having a propellor mounted for rotation about the longitudinal axes; U.S. Pat. No. 3,012,357 issued to Helin which disclosed a surface lure with a rotary blade mounted on the forward most end of the lure body. Two more examples are surface lures manufactured by Moudly Tackle company where the whopper stopper has contra rotating propellers mounted on a shaft that extends through a cigar-shaped body; and, the hog wobbler which uses a convex lip to produce a wobble when slowly retrieved.

All of the lures to date have shortcomings to overcome, some of which are: lures such as Dudeck' are not buoyant thus requiring a fast retrieve to remain on the surface; Norman's lure requires a steady strait line retrieve; Hanna's flotation device has a minimal effect on the lure's buoyancy; Bradly's lure does not resemble prey fish; Moudly's lures are not very durable.

Therefore, a need exists to overcome the problems with the prior art as discussed above.

### SUMMARY OF THE INVENTION

According to a preferred embodiment of the present invention, a hydrodynamic-effect surface lure is provided that can be retrieved with several speeds and styles. Also, according to a preferred embodiment, a surface lure is provided that more closely resembles the silhouette of prey fish. Further, another aspect of the present invention provides a surface lure that can have multiple actions imparted on it. Yet another aspect of the present invention provides a surface lure wherein the buoyancy is controlled by an internally mounted counter weight. According to another aspect of the present invention, a surface lure is more durable.

In accordance with a preferred embodiment of the present invention, a surface lure comprises a body means, a hydrodynamic lip means, a hook means, a line attachment means, a counterweight means, a propeller means, and a propeller stabilizer means. Advantageously, a fishing lure utilizing a preferred embodiment of the present invention is significantly more successful in attracting and catching large game fish, such as Muskie.

### BRIEF DESCRIPTION OF THE DRAWINGS

The subject matter, which is regarded as the invention, is particularly pointed out and distinctly claimed in the claims at the conclusion of the specification. The foregoing and other features and also the advantages of the invention will be apparent from the following detailed description taken in conjunction with the accompanying drawings.

FIG. 1 is an isometric view of a preferred embodiment the present invention.

FIG. 2 is a side elevational view of the preferred embodiment of the present invention.

FIG. 3 is a top view of the preferred embodiment of the present invention.

FIG. 4 is an end view of the preferred embodiment of the present invention.

FIG. 5 is a front view of the preferred embodiment of the present invention.

FIG. 6 is a side elevational view of a second embodiment of the present invention.

FIG. 7 is a top view of the second embodiment of the present invention.

FIGS. 8 to 11 illustrate bottom elevational views of skimmer lips for surface lures, according to alternative embodiments of the present invention.

### DETAILED DESCRIPTION

It is important to note that these embodiments are only examples of the many advantageous uses of the innovative teachings herein. In general, statements made in the specification of the present application do not necessarily limit any of the various claimed inventions. Moreover, some statements may apply to some inventive features but not to others. In general, unless otherwise indicated, singular elements maybe in the plural and visa versa with no loss of generality.

Preferred embodiments of the present invention provide a surface lure device that facilitates attracting and catching large game fish, such as Muskie.

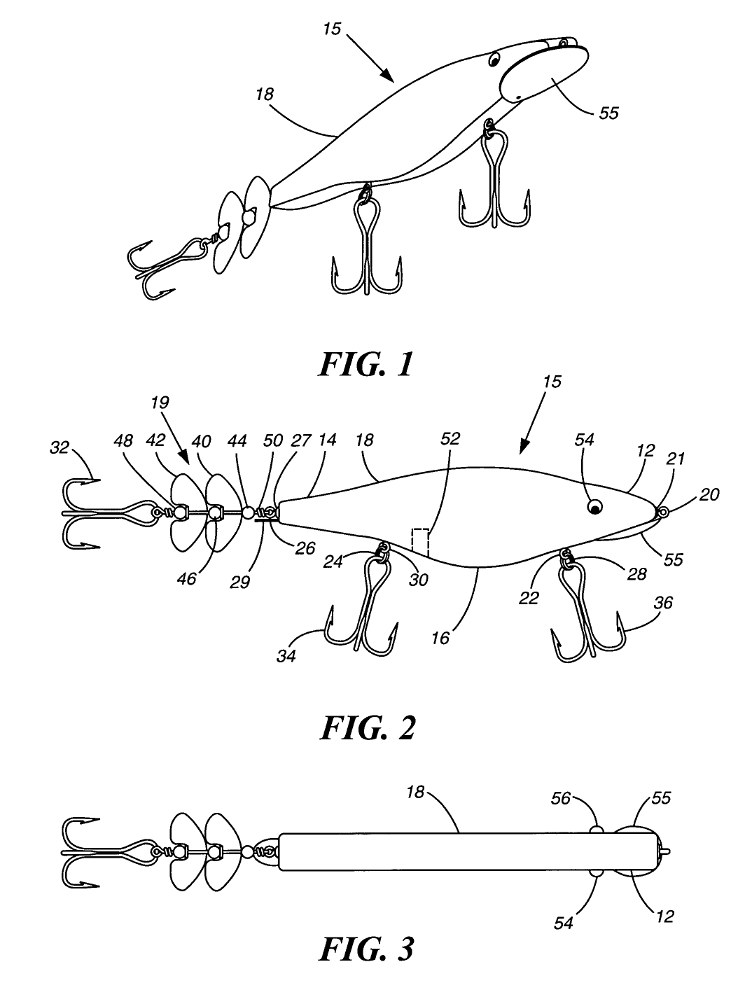

According to a preferred embedment of the present invention, a surface lure is indicated generally by the numeral 15 as shown in FIG. 1. The surface lure 15 comprises a body 18 which is formed out of a hard wood such as maple. Other buoyant materials such as molded plastic and other hard woods may be used.

Now referring to FIG. 2, a surface lure 15 comprises a body 18 generally conforming to the silhouette of prey fish, the lure 15 comprising a nose section 12, a belly section 16, and a tail section 14. The nose section 12 is generally rounded about the forward most end of the body 18 and forming a rearwardly arching acute angle, preferably in the range of 25 to 30 degrees, about the longitudinal axis of the body 18. The nose section 12 preferably constitutes approximately ⅕ the total length of the body 18. The tail section 14 is somewhat flat at the rearward most end of the body 18 and forming a forward slanting acute angle, preferably in the range of 15 to 25 degrees, about the longitudinal axis of the body 18.

The lower portion of the belly section 16 curves downward and rearward proximate the rearward most portion of the nose section 12 and then slants downward and rearward proximate the forward most portion of the belly section 16, rounding to a crest proximate the center of the body 18. The lower portion of the belly section 16 is preferably non-concentric and curves upward and rearward to form the tail section 14. The upper portion of the belly section 16 arches to a crest proximate but rearward to the center of the body 18. The arch is preferably somewhat symmetrical about the crest, then slanting rearward to form the tail section 14.

Now continuing with reference to FIG. 2, the surface lure 15 comprises the body 18, the nose section 12, the belly section 16, and the tail section 14. Means for attaching fishing line comprises an eyelet 20 with a cup washer 21 disposed centrally at the forward most end of the nose section 12. A hook 36 is loosely and movably coupled to a split ring 28 and then an eyelet 22 and securely affixed centrally to the lower most portion of the body 18, proximate the forward most portion of the belly section 16. A second hooking means comprising a hook 34, a split ring 30, and an eyelet 24, is securely affixed centrally to the lower most portion of the body 18, proximate the rearward most portion of the belly section 16. A counter weight 52 preferably is embedded within the body 18 preferably proximate but rearward to the center of the body 18. Of course, other locations for the counter weight 52 should be obvious to those of ordinary skill in the art in view of the present discussion.

A propeller stabilizer 29 is disposed centrally to the rearward most portion of the body 18 with an eyelet 26 and a cup washer 27. A propeller hook assembly 19 is loosely attached to the eyelet 26. The propeller hook assembly 19 comprises a spacer means 44, a propeller means 40, a spacer means 46, a propeller means 42, and a spacer means 48 disposed axially on a wire shaft 50. A hook 32 is attached loosely to the rearward most portion of the wire shaft 50.

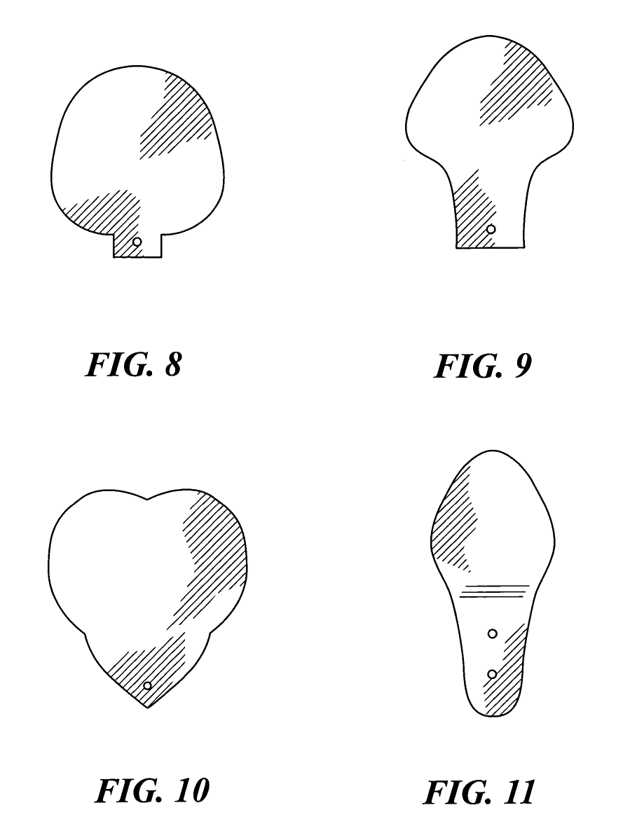

A skimmer lip 55, preferably comprises a tear dropped-shape spoon having a convex side and a concave side, such as a colorado spinner blade. The skimmer lip 55 is securely affixed centrally, proximate the forward most portion of the lower most portion of the nose section 12. The concave side of the skimmer lip 55 is adjacent the nose section 12. An epoxy adhesive or at least one screw, or other such fastening means, maybe used to secure the skimmer lip 55 to the body 18. The skimmer lip 55 preferably extends beyond the forward most end of the nose section 12 but not necessarily beyond the eyelet 20. As with most fishing lures an eye 54 is disposed at the rearward portion of the nose section 12. Now referring to FIG. 3, the skimmer lip 55 preferably is of sufficient size as to extend beyond the edges of the nose section 12. A second eye 56 is shown opposing the eye 54 and may be bulging from the body 18. Refer to FIG. 1 to better visualize the preferred physical relationship of the skimmer lip 55 and the body 18. Note also that FIGS. 8 to 11 illustrate alternative embodiments of the present invention utilizing different skimmer lips for surface lures. It should be obvious to those of ordinary skill in the art, in view of the present discussion, that further alternative shapes, mass, and sizes of skimmer lips may be utilized with surface lures to effect the advantages of the preferred embodiment of the present invention.

With reference to FIG. 2, note that by removing the propeller hook assembly 19 and the propeller stabilizer 29, a second embodiment of the present invention can be realized. Referring to FIG. 6, a hook 31 is attached to a split ring 56 and affixed to eyelet 226. This feature creates a second embodiment of the present invention by providing a modified surface lure 215.

### Operation of a Preferred Embodiment of the Present Invention

Referring to FIG. 2, the general function of the surface lure 15 can be effected by one or more factors, such as the size of the skimmer lip 55, the weight of the counter weight 52, the overall shape and mass of skimmer lip, and the relative size of the body 18. The counter weight 53 is preferably adjusted beyond the point of positive bouncy preferably keeping the center of gravity of the surface lure 15 rearward, a nose up position on the waters surface, and the tail portion 14 under the waters surface. The body 18 is preferably flat sided and slender as compared to it's length and shape. The skimmer lip 55 functions with a wide range of sizes for example colorodo deep cup blades number 6 through number 8.

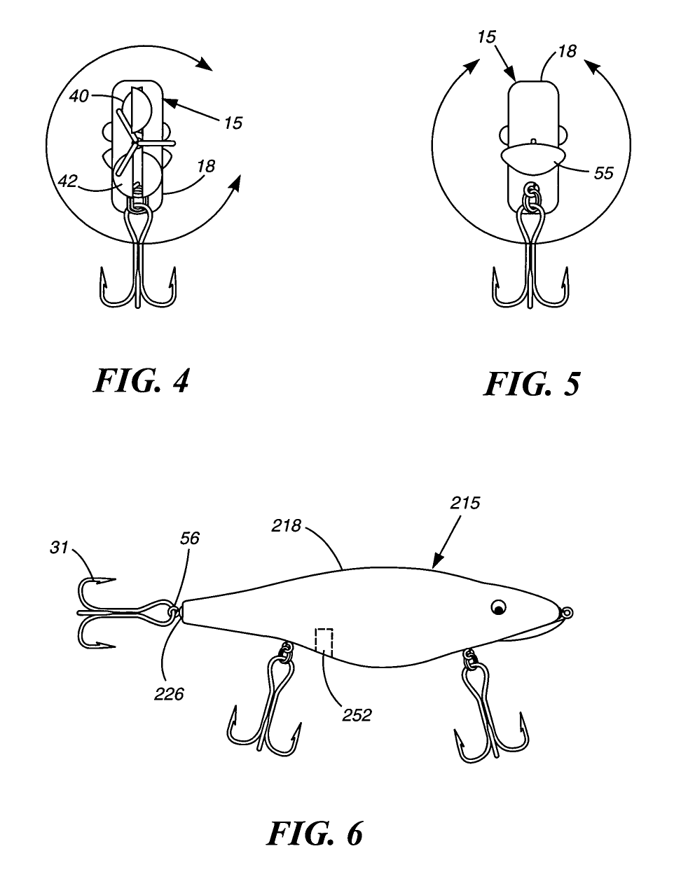

Now referring to FIG. 5, when the surface lure is retrieved across the surface of the water the skimmer lip 55 creates lift thus preventing the surface lure 15 to dive below the surface of the water. The convex shape of the skimmer lip 55 introduces a slight rolling action, as indicated by the arrow, and the relatively large flat surface of the body 18 interacts with wave action to magnify the roll and make the roll erratic. This roll is realized with virtually all retrieve speeds from stop and go to a slow steady retrieve even as fast as trolling speeds. FIG. 4 indicates the preferred action of the propellers 40 and 42 that are preferably contra-rotating relative to each other. The relatively large size of the body 18 somewhat restricts water flow across the propellers 40 and 42 thus reducing the amount of propeller splash and thereby making the surface lure 15 a more natural presentation as a prey fish.

Referring to FIG. 2, the propeller stabilizer 29 helps maintain the propeller hook assembly in an extended direction while casting the surface lure 15, effectively reducing hook fouling during the cast.

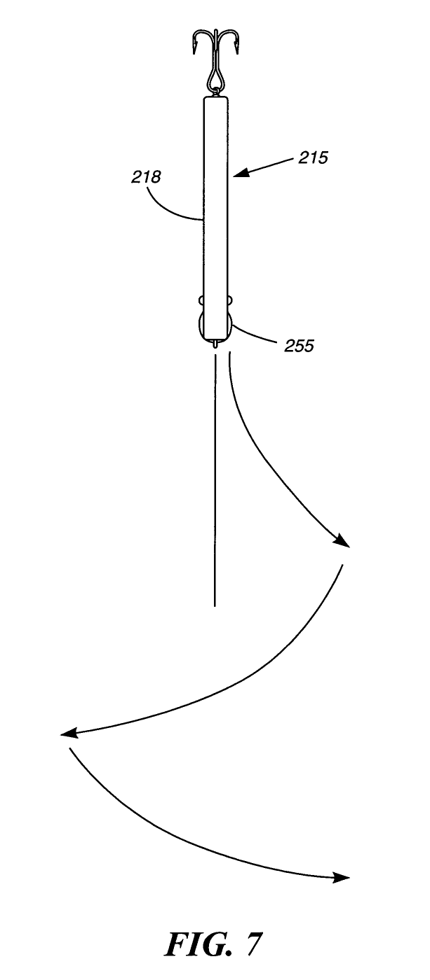

FIG. 7 illustrates the function of a second embodiment of the present invention. The modified surface lure 215 is retrieved with a snapping of the rod tip repeatedly. The relatively large size and convex shape of the skimmer lip 255 produces a side to side darting motion known as “walk the dog.” The relatively large profile of the modified surface lure 215 interacts with the water to produce a roll as illustrated by FIG. 5.

Referring to FIG. 6, the counter weight 252 preferably is adjusted rather heavy, to the point of almost sinking the modified surface lure 215. Now the modified surface lure 215 can be retrieved slowly across the surface with the “walk the dog” action as illustrated in FIG. 7. If the retrieve rate is speeded up, the modified surface lure 215 exhibits an erratic “walk the dog” action just bellow the surface of the water. The counter weight 252 preferably is heavy enough to counteract but not eliminate the hydrodynamics of the skimmer lip 255 and its interaction with the body 218. The result is a life like darting action at, and just below, the surface of the water. This is a significant advantage of the present invention. A preferred embodiment of the present invention provides a surface lure device that facilitates attracting and catching large game fish, such as Muskie.

Although specific embodiments of the invention have been disclosed, those having ordinary skill in the art will understand that changes can be made to the specific embodiments without departing from the spirit and scope of the invention. The scope of the invention is not to be restricted, therefore, to the specific embodiments, and it is intended that the appended claims cover any and all such applications, modifications, and embodiments within the scope of the present invention.

What is claimed is:

1. A surface fishing lure comprising:
a body having a forward portion and a rear portion;
a hydrodynamic lip mechanically coupled to the forward portion of the body for providing lift force to the surface fishing lure while moving through water thereby generally keeping the surface fishing lure near the surface of the water;
a hook coupling means, mechanically coupled to the body, for coupling a fishing hook thereto; and
a line coupling means, mechanically coupled to the body, for coupling a fishing line thereto.

2. The surface fishing lure of claim 1, wherein the hydrodynamic lip is generally shaped in an outwardly convex shape for providing a rolling action to the surface fishing lure while moving through the water.

3. The surface fishing lure of claim 1, further comprising:
a counterweight means, mechanically coupled to the body, for providing weight to the surface fishing lure to counter the buoyancy of the body while moving through the water;
a propeller means, mechanically coupled to the body, for providing a splash action to the surface fishing lure; and
a propeller stabilizer means, mechanically coupled to the body, for maintain the propeller means generally in an extended position relative to the body while casting the surface fishing lure.

4. The surface fishing lure of claim 1, wherein the hydrodynamic lip is affixed to the forward portion and lower side of the body thereby the surface fishing lure generally conforming to the silhouette of a prey fish while moving through the water.

5. A skimmer lip for a surface fishing lure, the skimmer lip comprising:
a skimmer lip body having a generally outwardly convex shape, the skimmer lip body for affixing to a forward portion of a surface fishing lure body for providing lift thereto while moving through the water.

6. The skimmer lip of claim 5, wherein the skimmer lip body for affixing to the forward portion and a lower side of the surface fishing lure body for providing a rolling action to the surface fishing lure while moving through the water.

7. The skimmer lip of claim 5, wherein the skimmer lip body creates an erratic walk the dog action for the surface fishing lure body while moving through the water and near or at the surface thereof.

8. A surface fishing lure comprising:
a generally slender elongated body having a forward portion and a rear portion;
a hydrodynamic lip mechanically coupled to the forward portion of the body for providing lift force to the surface fishing lure while moving through water thereby generally keeping the surface fishing lure near the surface of the water;
a counterweight means, mechanically coupled to the body, for providing weight to the surface fishing lure to counter the buoyancy of the body while moving through the water;
a propeller means, mechanically coupled to the body, for providing a splash action to the surface fishing lure;
a hook coupling means, mechanically coupled to the body, for coupling a fishing hook thereto; and
a line coupling means, mechanically coupled to the body, for coupling a fishing line thereto.

9. The surface fishing lure of claim 8, wherein the hydrodynamic lip and the generally slender elongated body generally conform to the silhouette of a prey fish.

10. The surface fishing lure of claim 8, wherein the hydrodynamic lip is affixed to the forward portion of the body for providing a wobble to the surface fishing lure, the wobble being magnified by wave action while the body moves near the surface of the water.

11. The surface fishing lure of claim 8, wherein the counterweight means is affixed to the rear portion of the body to keep the center of gravity of the surface fishing lure 15 rearward, a nose up position on the water surface, and the tail portion generally under the water surface.

12. The surface fishing lure of claim 8, further comprising:
a propeller stabilizer means, mechanically coupled to the body, for maintaining the propeller means generally in an extended position relative to the body while casting the surface fishing lure.

13. The surface fishing lure of claim 8, wherein the hydrodynamic lip allows the surface fishing lure to move at generally any speed through the water, even while trolling, without totally diving below the surface of the water.

14. The surface fishing lure of claim 8, wherein the hydrodynamic lip creates an erratic walk the dog action for the surface fishing lure while moving through the water and near or at the surface thereof.

15. The surface fishing lure of claim 8, wherein the counterweight means imparts on the surface fishing lure a generally nose up position while moving through the water
